(19) United States
(12) Patent Application Publication
(10) Pub. No.: US 2022/0333806 A1
(43) Pub. Date: Oct. 20, 2022

(54) DUAL TEMPERATURE SENSOR ARRANGEMENT TO DETECT REFRIGERANT LEAK

(71) Applicant: Carrier Corporation, Palm Beach Gardens, FL (US)

(72) Inventors: Richard G. Lord, Murfreesboro, TN (US); Larry D. Burns, Avon, IN (US)

(21) Appl. No.: 17/642,757

(22) PCT Filed: Sep. 11, 2020
(86) PCT No.: PCT/US2020/050423

§ 371 Date: Mar. 14, 2022

Related U.S. Application Data
(60) Provisional application No. 62/899,439, filed on Sep. 12, 2019.

(51) Int. Cl. F24F 11/36; G01K 13/02; F25B 49/02; F24F 11/74

(52) U.S. Cl. CPC F24F 11/36; G01K 13/02; F25B 49/022; F24F 11/74; G01K 2201/00; F25B 2313/0293; F25B 2313/0314; F25B 2500/222; F25B 2700/2103

(57) ABSTRACT

Disclosed is an air conditioning system having: a first HVAC assembly comprising an indoor heat exchanger and a fan; a first sensor, configured to sense a first temperature reading, operably coupled to the indoor heat exchanger; a second sensor, configured to sense a second temperature reading, positioned downstream of the first sensor and detached from the indoor heat exchanger; and a system controller configured to activate the fan to deliver airflow across the indoor heat exchanger when the difference between the first temperature reading and the second temperature reading is greater than or equal to a predetermined threshold, the temperate differing being checked when the first HVAC assembly is in an inactive mode and the fan and a compressor operably connected to the first HVAC assembly are in an inactive mode.

### CROSS REFERENCE TO RELATED APPLICATIONS

This application claims the benefit of U.S. Application No. 62/899,439, filed on Sep. 12, 2019, which is incorporated herein by reference in its entirety.

### BACKGROUND

The presently disclosed embodiments generally relate to heating, ventilation, air conditioning, and refrigeration (HVAC/R) systems, and more particularly, to a dual temperature sensor arrangement to detect a refrigerant leak.

Refrigeration systems, as used in HVAC/R applications, utilize a closed loop refrigerant circuit to condition air inside an interior or enclosed space. Modern refrigerants comply with environmental regulations relating to global warming potential (GWP). In order to comply with the proposed GWP regulations, hydrofluorocarbon (HFC) and hydrocarbon refrigerants with various levels of flammability are being developed and are being considered for use in HVAC/R systems.

As with any system, there is a potential for flammable refrigerants used in HVAC/R applications to leak and migrate to undesirable areas in the vicinity of the HVAC/R system that may contain an ignition source. When the flammable refrigerants, in the presence of air or another oxidizer, are exposed to an ignition source, the potential for a combustion event exists if the mixture is above the lower flammability limit (LFL) and below the upper flammability limit (UFL).

### SUMMARY OF THE DISCLOSED EMBODIMENTS

Disclosed is an air conditioning system comprising: a first HVAC assembly including an indoor heat exchanger and a fan; a first sensor, configured to sense a first temperature reading, operably coupled to the indoor heat exchanger; a second sensor, configured to sense a second temperature reading, positioned downstream of the first sensor and detached from the indoor heat exchanger; and a system controller configured to activate the fan to deliver airflow across the indoor heat exchanger when the difference between the first temperature reading and the second temperature reading is greater than or equal to a predetermined threshold, the temperate differing being checked when the first HVAC assembly is in an inactive mode and the fan and a compressor operably connected to the first HVAC assembly are in an inactive mode.

In addition to one or more of the above disclosed aspects or as an alternate the system controller is further configured to communicate an alarm and activate the fan to thereby dilute leaking refrigerant when the difference between the first temperature reading and the second temperature reading is greater than or equal to the predetermined threshold.

In addition to one or more of the above disclosed aspects or as an alternate the system includes a second HVAC assembly operably coupled to the first HVAC assembly, wherein the second HVAC assembly comprises the compressor and outdoor heat exchanger.

In addition to one or more of the above disclosed aspects or as an alternate the system controller is configured to deactivate an active air conditioning cycle for the air conditioning system when the difference between the first temperature reading and the second temperature reading is greater than or equal to the predetermined threshold.

In addition to one or more of the above disclosed aspects or as an alternate the system controller is configured to determine whether the first HVAC assembly and second HVAC assembly have been inactive for a predetermined period of time.

In addition to one or more of the above disclosed aspects or as an alternate the predetermined period of time is approximately 10 minutes.

In addition to one or more of the above disclosed aspects or as an alternate the predetermined threshold is a temperature difference of approximately ten to fifteen degrees Fahrenheit.

Further disclosed is an HVAC assembly including: a heat exchanger; a fan, configured to deliver airflow across the heat exchanger to an interior of a structure; a first sensor, configured to sense a first temperature reading, connected to the heat exchanger; a second sensor, configured to sense a second temperature reading, positioned downstream of the first sensor and detached from the heat exchanger; and a system controller operably coupled to the fan, the system controller configured to activate the fan when the difference between the first temperature reading and the second temperature reading is greater than or equal to a predetermined threshold.

In addition to one or more of the above disclosed aspects or as an alternate the system controller is further configured to communicate an alarm and activate the fan to thereby dilute leaking refrigerant when the difference between the first temperature reading and the second temperature reading is greater than or equal to the predetermined threshold.

In addition to one or more of the above disclosed aspects or as an alternate the system controller is configured to deactivate an active air conditioning cycle when the difference between the first temperature reading and the second temperature reading is greater than or equal to the predetermined threshold.

In addition to one or more of the above disclosed aspects or as an alternate the system controller is configured to determine at least one of an air conditioning cycle or the fan have been inactive for a predetermined period of time.

In addition to one or more of the above disclosed aspects or as an alternate the predetermined period of time is approximately 10 minutes.

In addition to one or more of the above disclosed aspects or as an alternate the predetermined threshold is a temperature difference of approximately ten to fifteen degrees Fahrenheit.

Further disclosed is a method of monitoring for a refrigerant leak in an HVAC assembly of an air conditioning system comprising: receiving a first temperature reading from a first sensor connected to an indoor heat exchanger of the HVAC assembly of the air conditioning system; receiving a second temperature reading from a second sensor disposed within the HVAC assembly and detached from the indoor heat exchanger; and activating a fan to deliver airflow across the indoor heat exchanger when the difference between the first temperature reading and the second temperature reading is greater than or equal to a predetermined threshold.

In addition to one or more of the above disclosed aspects or as an alternate the method includes communicating an alarm at a system control panel when the difference between the first temperature reading and the second temperature reading is greater than or equal to a predetermined threshold.

In addition to one or more of the above disclosed aspects or as an alternate the method includes deactivating an active air conditioning cycle for the air conditioning system when the difference between the first temperature reading and the second temperature reading is greater than or equal to a predetermined threshold.

In addition to one or more of the above disclosed aspects or as an alternate the method includes determining whether the air conditioning system has been inactive for a predetermined period of time.

In addition to one or more of the above disclosed aspects or as an alternate the predetermined period of time is approximately 10 minutes.

In addition to one or more of the above disclosed aspects or as an alternate the predetermined threshold is a temperature difference of approximately ten to fifteen degrees Fahrenheit.

### BRIEF DESCRIPTION OF DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 shows an indoor HVAC assembly with dual temperature sensors to detect a refrigerant leak according to an embodiment; and

FIG. 2 a flowchart showing a method of detecting a refrigerant leak according to an embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

With the requirements to move to lower GWP refrigerants it is likely that mildly flammable refrigerants, referred to in the art as “A2L refrigerants”, will be used. A direct method will be required for most applications by safety standards to detect leaks using a refrigerant sensor. However, other methods of detecting leaks is desirable to confirm the detection and provide added protection.

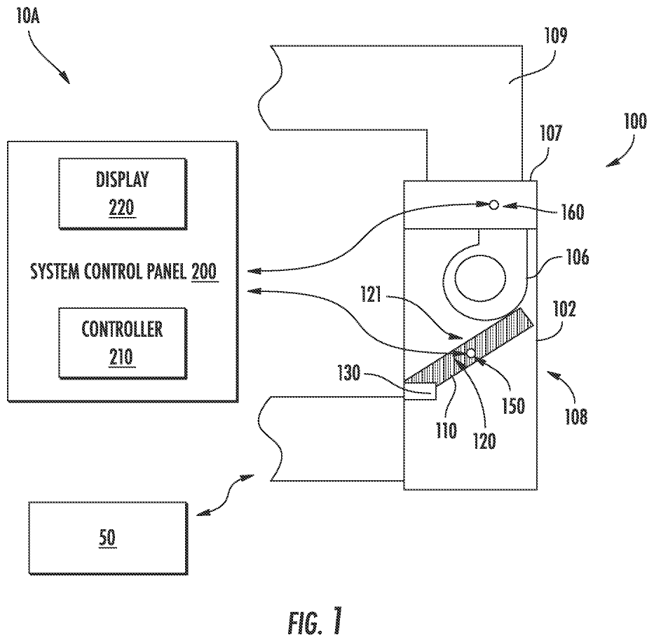

Turning to FIG. 1, an air conditioning system 10A that includes a second HVAC assembly 50, including a compressor and outdoor heat exchanger therein (illustrated schematically) operationally connected to a first HVAC assembly 100 (otherwise generally referred to herein as the HVAC assembly 100). It will be appreciated that the air conditioning system 10A can be used in a number of applications. For example, the air conditioning system may be a residential split system where the second HVAC assembly 50 is located outside a structure and operates as condenser or heat pump; the first HVAC assembly 100 is located inside a structure and operates as a fan coil or furnace/cased coil combination. In another example, the air conditioning system 10A may be a packaged residential or commercial rooftop system. In this configuration, the first and second HVAC assembly are combined into one housing and located on a rooftop or an exterior of a structure. The first HVAC assembly 100 operates as an evaporator section and draws air from inside the structure, conditions it, and directs the air back into the structure. The second HVAC assembly 50 operates as a condenser section and draws ambient air through an outdoor heat exchanger (not shown) for heat exchange with the refrigerant.

In the embodiment shown in FIG. 1, the first HVAC assembly 100 includes a housing 102 and a fan 106 configured to direct air across an indoor heat exchanger 108. The indoor heat exchanger 108 may be a microchannel coil or a round tube plate fin coil. The first HVAC assembly 100 is positioned adjacent an exhaust plenum 107. The exhaust plenum 107 is connected to supply ductwork 109 to provide conditioned air to the interior of a structure. It is to be appreciated that benefits of the disclosed embodiments may be applied to other types of coils than the fan coil illustrated in FIG. 1, such as a furnace/cased coil combination. The indoor heat exchanger 108 includes a first end 120 which may be a header end and a second end 121 which may be a hairpin end. A drain pan 130 is located below the indoor heat exchanger 108 and is configured to capture condensate from the indoor heat exchanger.

According to an embodiment, a first sensor 150, configured to sense a first temperature reading, is connected to the indoor heat exchanger 108 or in close proximity to an area where a refrigerant leak could occur. A second sensor 160, configured to sense a second temperature reading, is positioned downstream of the first sensor 150. In the embodiment shown, the second sensor 160 is shown in the exhaust plenum 107 downstream of the fan 106. It will be appreciated that second sensor 160 may be attached to or detached from the first HVAC assembly 100.

A system control panel 200, illustrated schematically, is operably coupled to the air conditioning system 10A. It will be appreciated that the system control panel 200 may be internal or external to the first HVAC assembly 100. The system control panel includes a system controller 210 configured to activate the fan 106 when the difference between the first temperature reading and the second temperature reading is greater than or equal to a predetermined threshold. The temperature difference is checked when the first HVAC assembly 100 is an inactive mode and the fan 106 and the compressor are in an inactive mode. In one embodiment the predetermined threshold is ten to fifteen degrees. In one embodiment the degrees are measured on the Fahrenheit scale. In some embodiments, the system control panel includes a display 220 operably coupled to the system controller 210. The controller 210 may be configured to communicate an alarm or flash a warning through the display 220 to alert when the difference between the first temperature reading and the second temperature reading is greater than or equal to a predetermined threshold. The system controller 210 may be further configured to prevent the first HVAC assembly 100 and/or second HVAC assembly 50 from operating when the difference between the first temperature reading and the second temperature reading is greater than or equal to a predetermined threshold.

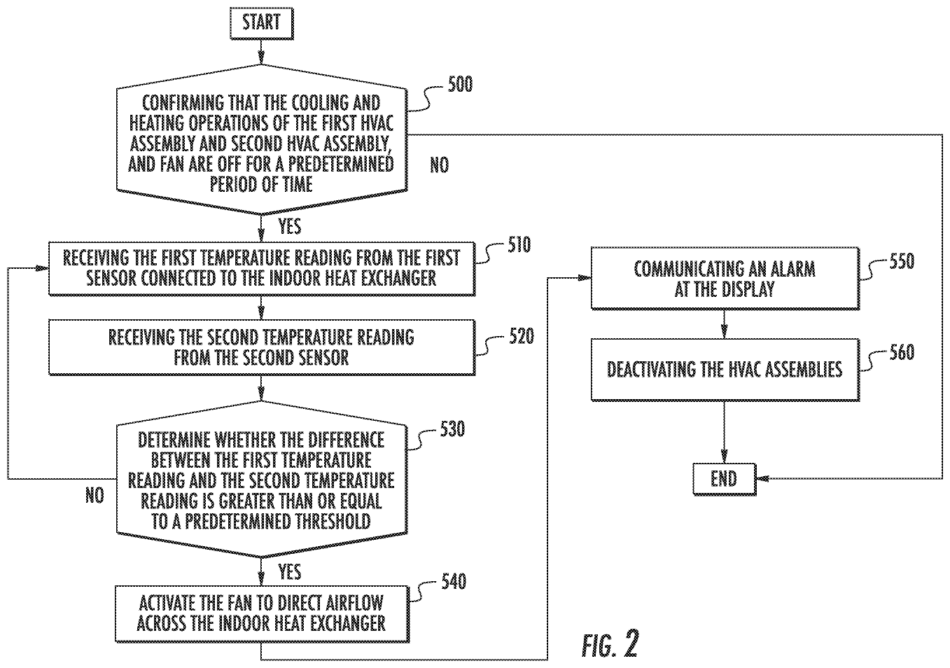

Turning to FIG. 2, a method is illustrated of monitoring for a refrigerant leak in an air conditioning system 10A. As illustrated in block 500, the method includes operating the system control panel 200 to monitor the operating condition of the air conditioning system 10A. In an embodiment, monitoring the operating condition of the air conditioning system 10A includes confirming that the cooling and heating operations of the first HVAC assembly 100 and second HVAC assembly 50, and fan 106 are off for a predetermined period of time. In an embodiment, the predetermined period of time is about ten minutes. It will be appreciated that the predetermined period of time may be less than or greater than ten minutes.

If this condition is satisfied (YES at 500) then as illustrated in block 510 the method includes operating the system control panel 200 to receive the first temperature reading from the first sensor 150 connected to the indoor heat exchanger 108. As illustrated in block 520 the method includes operating the system control panel 200 to receive the second temperature reading from the second sensor 160.

As illustrated in block 530 the method includes operating the system control panel 200 to determine whether the difference between the first temperature reading and the second temperature reading is greater than or equal to a predetermined threshold. When the determination is NO at block 530 then the method cycles back to block 510. When the determination is YES at block 530 then as illustrated in block 540 the method includes operating the system control panel 200 to activate the fan 106 to direct airflow across the indoor heat exchanger 108. As illustrated in block 550 the method may further include operating the system control panel 200 to communicate an alarm at the display 220. As illustrated in block 560 the method may further include operating the system control panel 200 to deactivate the air conditioning system 10A.

The above disclosed embodiments provide installing a first temperature sensor 150 in first area that is an area of potential leaks. A second temperature sensor 160 is installed in a second area that is near an outlet of the first HVAC assembly 100. By comparing the two temperatures at the outlet of the first HVAC assembly 100 and near the indoor heat exchanger 108, the system control panel 200 may execute the method herein to determine whether a leak may have occurred. As refrigerant leaks, a temperature at the first temperature sensor 150 will drop relatively quickly. This is because refrigerants boil at well below zero Fahrenheit (e.g. −57° F. for R-454B) when released to the atmosphere. A potential leak may be detected when a defined delta between the measured temperatures is reached.

When a leak is detected the mitigation would be enabled by turning on the fan 106 which quickly dilutes the refrigerant to a non-flammable composition. Air would be circulated by the fan 106 for a predetermined period. Thereafter, an alarm or warning may be communicated to one or more of controls, displays or thermostats.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits. The disclosed embodiments enable the use of detecting a leak without direct measure of the refrigerant leaks.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What we claim is:

1. An air conditioning system comprising:
a first HVAC assembly comprising an indoor heat exchanger and a fan;
a first sensor, configured to sense a first temperature reading, operably coupled to the indoor heat exchanger;
a second sensor, configured to sense a second temperature reading, positioned downstream of the first sensor and detached from the indoor heat exchanger; and
a system controller configured to activate the fan to deliver airflow across the indoor heat exchanger when the difference between the first temperature reading and the second temperature reading is greater than or equal to a predetermined threshold, the temperate differing being checked when the first HVAC assembly is in an inactive mode and the fan and a compressor operably connected to the first HVAC assembly are in an inactive mode.

2. The system of claim 1, wherein the system controller is further configured to communicate an alarm and activate the fan to thereby dilute leaking refrigerant when the difference between the first temperature reading and the second temperature reading is greater than or equal to the predetermined threshold.

3. The system of claim 1, further comprises a second HVAC assembly operably coupled to the first HVAC assembly, wherein the second HVAC assembly comprises the compressor and outdoor heat exchanger.

4. The system of claim 3, wherein the system controller is configured to deactivate an active air conditioning cycle for the air conditioning system when the difference between the first temperature reading and the second temperature reading is greater than or equal to the predetermined threshold.

5. The system of claim 3, wherein the system controller is configured to determine whether the first HVAC assembly and second HVAC assembly have been inactive for a predetermined period of time.

6. The system of claim 5, wherein the predetermined period of time is approximately 10 minutes.

7. The system of claim 1, wherein the predetermined threshold is a temperature difference of approximately ten to fifteen degrees or greater.

8. An HVAC assembly comprising:
a heat exchanger;
a fan, configured to deliver airflow across the heat exchanger to an interior of a structure;
a first sensor, configured to sense a first temperature reading, connected to the heat exchanger;
a second sensor, configured to sense a second temperature reading, positioned downstream of the first sensor and detached from the heat exchanger; and
a system controller operably coupled to the fan, the system controller configured to activate the fan when the difference between the first temperature reading and the second temperature reading is greater than or equal to a predetermined threshold, the temperate differing being checked when the HVAC assembly is in an inactive mode and the fan and a compressor operably connected to the HVAC assembly are in an inactive mode.

9. The assembly of claim 8, wherein the system controller is further configured to communicate an alarm and activate the fan to thereby dilute leaking refrigerant when the difference between the first temperature reading and the second temperature reading is greater than or equal to the predetermined threshold.

10. The assembly of claim 9, wherein the system controller is configured to deactivate an active air conditioning cycle when the difference between the first temperature reading and the second temperature reading is greater than or equal to the predetermined threshold.

11. The assembly of claim 8, wherein the system controller is configured to determine at least one of an air conditioning cycle or the fan have been inactive for a predetermined period of time.

12. The assembly of claim 8, wherein the predetermined period of time is approximately 10 minutes.

13. The assembly of claim 8, wherein the predetermined threshold is a temperature difference of approximately ten to fifteen degrees Fahrenheit.

14. A method of monitoring for a refrigerant leak in an HVAC assembly of an air conditioning system comprising:
receiving a first temperature reading from a first sensor connected to an indoor heat exchanger of the HVAC assembly of the air conditioning system;
receiving a second temperature reading from a second sensor disposed within the HVAC assembly and detached from the indoor heat exchanger; and
activating a fan to deliver airflow across the indoor heat exchanger when the difference between the first temperature reading and the second temperature reading is greater than or equal to a predetermined threshold, the temperate differing being checked when the first HVAC assembly is in an inactive mode and the fan and a compressor operably connected to the first HVAC assembly are in an inactive mode.

15. The method of claim 14, comprising communicating an alarm at a system control panel and activating the fan to thereby dilute leaking refrigerant when the difference between the first temperature reading and the second temperature reading is greater than or equal to a predetermined threshold.

16. The method of claim 14, comprising deactivating an active air conditioning cycle for the air conditioning system when the difference between the first temperature reading and the second temperature reading is greater than or equal to a predetermined threshold.

17. The method of claim 14, comprising determining whether the air conditioning system has been inactive for a predetermined period of time.

18. The method of claim 17, wherein the predetermined period of time is approximately 10 minutes.

19. The method of claim 14, wherein the predetermined threshold is a temperature difference of approximately ten to fifteen degrees Fahrenheit.
